(19) United States
(12) Patent Application Publication
(10) Pub. No.: US 2012/0095866 A1
(43) Pub. Date: Apr. 19, 2012

(54) METHOD AND SYSTEM FOR E-COMMERCE CONTROLLER

(75) Inventors: Peter John CAIAZZI, MILANO (MI) (IT); Michele CASUCCI, MILANO (MI) (IT)

(73) Assignee: CERTILOGO S.P.A., MILANO (IT)

(21) Appl. No.: 13/272,903

(22) Filed: Oct. 13, 2011

(30) Foreign Application Priority Data
Oct. 14, 2010 (IT) MI2010A001879

(51) Int. Cl. G06Q 30/00

(52) U.S. Cl. 705/26.35

(57) ABSTRACT

A method and system for verifying authenticity of items sold online through e-commerce sites are described. A verification server performs a post purchase authentication of products previously pre-authenticated by the seller. The pre-authentication includes a verification of whether a code matches with a corresponding item as indicated by the seller.

### CROSS REFERENCE TO RELATED APPLICATIONS

The present application claims priority to Italian Patent Application No. MI2010A001879 filed on Oct. 14, 2010, which is incorporated herein by reference in its entirety.

### FIELD

The present disclosure relates to a method and system for e-commerce controller and, more particularly, for checking the authenticity of items sold online through e-commerce sites.

### BACKGROUND

The widespread diffusion of Internet-based sales (also known as e-commerce) has brought unexpected marketing opportunities, but has also introduced new issues for the authenticity of goods on sale, since Internet has become an ideal distribution channel for deceptive counterfeits of branded products. Fraudsters can take advantage of the fact that the world's manufacturing is shifting towards low-cost countries with poor protection of intellectual property but sufficient technology to provide them with non-evident fakes. They also benefit from the possibility of reaching millions of consumers with very little effort and almost no risk via the Internet. Knowing that consumers can only judge by appearance while surfing for shopping opportunities they have become experts at creating professional-looking sites or ads, and even using social media to lure shoppers to them.

For brands, the problem with counterfeiting is more challenging than ever before. In fact, in the past, it was primarily an image problem related to evident fakes sold offline. Today, it is also a business problem related to the revenue loss associated with deceptive fakes sold online to misled or unsuspicious consumers.

For consumers who want to purchase articles on the web it is difficult to understand which goods can be trusted as original and how to distinguish fakes from authentic goods. Many consumers know this and act accordingly. Some consumers for instance choose to buy only from the brand's online store or from online retailers with widely known household names.

The large number of non-authentic goods available on the web is, therefore, also a big problem for honest retailers because of the risk of general lack of trust from the customers. Being able to reassure potential buyers about the authenticity of merchandise is a crucial concern for Internet sellers because trust is crucial when it comes to selling branded products over the Internet. Since e-commerce marketplaces are often filled with fakes, consumers have become insecure and therefore expect a sort of “risk discount” while assessing shopping opportunities, resulting in lower prices that squeeze the profit margins of honest online retailers. For honest sellers, it is difficult to distinguish themselves from sellers of fake products, who clutter their Internet sites' pages with claims like “100% Authentic”, “Guaranteed Original”, etc., knowing that consumers have no choice but to judge appearance. In fact, e-shoppers can only examine the product photos and judge from the price. However photos can be deceptive or just plain fake and bargain prices are quite common on the Internet. That's how millions of fake products are sold over the Internet to misled or unsuspicious consumers who have limited possibilities to check the authenticity of those products neither before nor after their purchase.

In order to alleviate this problem, a number of methods are available, based on verification or certification codes (product identifiers) that can be checked by consumers to verify if such codes correspond to an authentic item. As an example, International patent applications WO 2005/083644 A1 and WO 2006/100581 A2 disclose possible methods for implementing and managing verification. Furthermore, there are commercially available systems, including Dacom's (at the website sixtrue.com), Export Box Madeinitaly.com (at the website madeinitaly.com), and Certilogo's (at the website certilogo.com), that perform an authentication of the product, by initially providing a verification code, to determine if such codes correspond to an authentic item. These verification methods work reasonably well when the customer can see and physically touch the product as normally happens in a traditional retail outlet (the so called “brick and mortar” physical shop). On the contrary, when items are on sale on the Internet, existing systems including those described above are not effective. Even when the verification code is valid and the system is reasonably sure that the product is authentic, there is no assurance that the online seller would ship the authenticated product that was advertised: for example, the seller could have one authentic item and then ship a counterfeit, or have simply copied a valid verification code from a shop and used it to advertise counterfeits of the same exact product. In the above cases, the verification codes would be valid, but the item shipped to the customer would not correspond to the item uniquely identified by that code. Therefore, a method and system that helps to detect illicit and/or improper use of verification codes in the context of online sales would be desirable.

### SUMMARY

In accordance with several embodiments of the present disclosure, a technology is provided that overcomes, at least partially, the disadvantages of the presently available systems.

According to an aspect of the present disclosure, a method for detecting improper use of verification codes of a set of items sold through an e-commerce site connectable to a verification server is provided, the verification server having access to a repository containing information on a plurality of items, each item being associated with a verification code and with a plurality of item-related features, each item of the set of items having been pre-authenticated by a seller through the verification server, wherein the pre-authentication includes checking a verification code and at least one pre-authentication item-related feature selected among the plurality of predetermined item-related features associated to the item, the method including the steps: responsive to a user request to verify the authenticity of an item purchased through the e-commerce site, the verification server prompting the user to provide a verification code; the verification server determining the validity of the code by querying the repository; responsive to the code being determined valid, the verification server selecting at least one item-related feature among the plurality of predetermined item-related features and for each selected item-related feature obtaining information from the user; comparing the information obtained by the user with the at least one selected item-related feature to verify the authenticity of the purchased item; assigning to the item a score based on the comparison, the score being indicative of the likelihood that the purchased item is authentic; providing the user with a feedback according to the assigned score.

The at least one selected item-related feature for which information is obtained from the user corresponds to the at least one pre-authentication item-related selected feature. In a further embodiment of the present disclosure, the step of obtaining information from the user includes an interactive dialogue. Such dialogue can include showing a visual representation of an item-related feature and wherein the user is requested to confirm the conformity of the purchased item with the shown visual representation.

Furthermore, the pre-authentication is a pre-requisite for selling items through the e-commerce site. This requisite could be conveyed to the possible customers by means of a message displayed on the e-commerce site advising the users that the specific product has been previously pre-authenticated by the seller and of the possibility of controlling authenticity of purchased items after the purchase has been completed.

According to further embodiments of the present disclosure, a computer program, a software application or a program product that implement the above method, when run on a computer or any apparatus capable of data processing, are provided.

A data processing system implementing the above method is also provided.

In accordance with the teachings of the present disclosure, it is possible to increase the trust of the customers with e-commerce purchases because a system combining a pre-authentication step and a post purchase verification check is provided by an external entity by means of a verification server.

### BRIEF DESCRIPTION OF THE DRAWINGS

The features of the present disclosure will be better understood by any person skilled in the art from the following description and the enclosed drawings, referring to embodiments, which are to be considered exemplary and not restrictive, in which:

FIG. 1 illustrates the general architecture of a system according to an embodiment of the present disclosure;

FIG. 2 illustrates schematically a generic computer used in the system according to an embodiment of the present disclosure;

FIG. 3 illustrates schematically the user interface for pre-authenticating a product which is put on sale online;

FIG. 4 illustrates how the result of pre-authentication is represented on the e-commerce site;

FIG. 5 illustrates schematically the user interface for post-authenticating a product which has been purchased online;

FIG. 6 illustrates schematically the steps of a pre-authentication method according to an embodiment of the present disclosure;

FIG. 7 illustrates schematically the steps of a post purchase authentication method according to an embodiment of the present disclosure.

### DETAILED DESCRIPTION

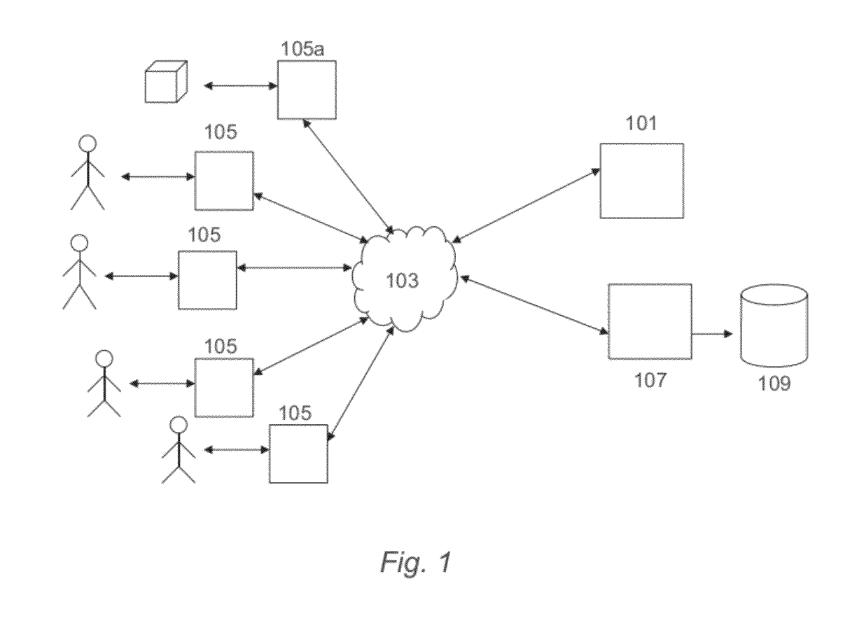

As shown schematically in FIG. 1, the architecture according to an embodiment of the present disclosure includes a server 101 (or a plurality of servers), which can be accessed through a network 103 by a plurality of clients 105. Throughout the present disclosure, the term “server” will indicate any data processing system adapted to provide, through one or more software applications, a response reacting to an external request (e.g. received from one or more client data processing systems). The server 101 provides access to e-commerce sites, while the network 103 can be, for example, the Internet. The plurality of clients 105 allow the connection to the services offered by the server 101 including buying items from a seller associated (or subscribed) with such server. Clients 105 can also be used by sellers, manufacturers or retailers to connect to the e-commerce server 101. Those skilled in the art will appreciate that, as an alternative, clients could be used in an automated way (see 105a), not requiring human intervention, e.g. by auction management systems, e-commerce or catalog management systems, enterprise resource planning (ERP) systems, manufacturing resource planning (MRP) systems, to connect to the Internet and then to e-commerce server 101 and any other server connected therein. Server 101 and clients 105 can also communicate, through network 103, with a verification server 107 which has access to repository 109 containing information on items on sale and related verification (or certification) codes. Throughout the present disclosure, the term “verification server” will indicate a server with an application running on it adapted to interact with one or more repositories in order to check authenticity of commercial products. Repository 109 is illustrated as a single data base, but those skilled in the art will appreciate that it can include several different data bases local or remotely accessible, e.g. through a network. The product features are provided to the verification server, each associated with a verification code, typically by the brand owner or brand licensee, or by anyone who has a real interest in protecting the authenticity of products. The verification codes and verification process would typically be offered as a service by a third party company, such as Certilogo SpA, to the brand, its consumers, its third party inspectors, customs officials on the brand's behalf, and other interested parties. The verification codes or verification process, hosted on the verification server 107, could be managed directly by the brand, however usually they are deployed and managed by specialized firms as for example Certilogo SpA of Milan, Italy.

In an embodiment of the present disclosure, the verification server 107 can be, for example, a JBoss application server (version 5.1) on which a software application implemented in the Java programming language is running, using the Java Virtual Machine (version 1.6), with a repository 109 implemented using Postgres (version 8), both running on IBM computer servers with a Linux operating system (version SuSe 10). Server 101 can be any server suitable for controlling access to web sites on the Internet, while client computers 105 can be, e.g., any computer capable of running a browser (e.g., Microsoft Explorer) and connecting to the Internet, but any device with network capability could be used instead.

From the customers' point of view, in a further embodiment of the present disclosure, a plurality of certified items are available on sale through server 101, each item having a unique verification code which has been previously authenticated by the seller through verification server 107. When a potential customer visits an e-commerce site on server 101 through network 103, a selection of items are available for purchase. In accordance with a further embodiment of the disclosure, some or all of the items are certified. Certified items have been pre-authenticated by the verification server 107 and the potential customer can see this information when deciding to buy the item.

Such pre-authentication was based on information provided by the seller and allows to establish whether the verification code matches with a corresponding product (item) as indicated by the seller. As an example, the verification code can verify some features of the product as described by the seller and compare these features with those of the expected product as defined by the producer (who is normally the owner of the verification code).

After the purchase process has been completed, the customer should receive the product at the indicated address: according to an embodiment of the present disclosure, the system implements a post-purchase verification step based on an analysis of information provided by the customer, in order to check whether the features declared by the seller correspond to those of the delivered product. Again, the mere verification code may not be sufficient to ensure that the product is authentic. However, a combination of verification code and a list of features which are “extracted” from the product itself can provide a higher level of trust. As an example, let's suppose that the product on sale is a fashion bag. If the seller wants to pre-authenticate the product, an approved verification code should be provided to the verification server 107.

The seller will connect from a client 105 to the verification server 107 through network 103 (e.g., the Internet). The product will be put on sale on a web-based e-commerce site on the server 101, accessible by a plurality of clients 105 (which can be either sellers or buyers) through the network 103. The verification server 107 will perform a formal check of the verification code on the repository 109 to verify the existence and the status of the code (e.g., the code might have been stolen from a producer or blocked after a license to produce branded goods was cancelled). If the code does exist and it is valid, i.e. the status does not suggest any evident misuse or any reasons for preventing the sale, the server will compare some features of the product for which the pre-authentication is requested with the information recorded on the repository 109 for the product associated with the code. Such additional information will be obtained from the seller in several possible ways: according to an embodiment of the present disclosure, the seller will be prompted to enter a plurality of features as answers to specific questions from the server. Such questions can be a predetermined list of questions indicated by the producer, or possibly a subset of a larger number of questions selected by the server, e.g., as a random choice. Those skilled in the art will appreciate that such step of acquiring information on the product can be performed in several different ways—manually or automatically—one item at a time or several at a time, e.g., automatic submission of files (e.g. XML) populated with the data required by the verification system from corporate information systems (e.g. ERP, MRP, Auction Management and Catalog Systems, etc.).

After such pre-authentication step is completed, the seller will be authorized to display a sort of certification on the web site to advertise the pre-authentication to possible customers. This could be done, for example, by way of a banner that distinguishes the pre-authenticated products, or a “clickable” button found on the pre-authenticated product's page that redirects prospective consumers to the verification service's site, encouraging the post-purchase authentication and explaining the guarantee offered in case of an eventual purchase.

A customer who wants to purchase a pre-authenticated item, knows (e.g., by reading the instructions on the web site) that a pre-authentication has already been performed by the seller and a post-sale authenticity check is available if the product is purchased on such web site. In this way, the customer is informed that the seller is willing to have all advertised products checked by an independent authority. Ideally, the seller could offer a guarantee to the buyer in case the post-sale verification fails.

When the buyer receives the purchased product, a post-purchase authentication check can be performed through the same verification server 107. Again the buyer can connect to the verification server 107 from one of the plurality of clients 105 through network 103. The verification server 107 will request the buyer to provide a verification code and a set of features to verify whether the product matches with the information stored on repository 109 as associated to the code provided by the buyer. If the comparison reaches a satisfactory threshold, the product is rated as authentic and the purchase process is considered successfully completed. Otherwise, an alert is issued to let the buyer know that further investigations are needed to determine the authenticity of the purchased product. This warning message (the alert) can be delivered in several different ways, as later described.

Throughout the present disclosure, the term “e-commerce sites” is being used to refer to all Internet sites where goods can be found or purchased, including online retailers, online marketplaces, and online classified sites.

Online retailers can be Internet sites that sell goods and services directly to consumers, generally offering online payment. Examples of online retailers include the websites at saksfifthavenue.com, apple.com, and net-a-porter.com.

Online marketplaces can be Internet sites that connect buyers and sellers from disparate locations, facilitate online payment, and generally manage their user community. Examples of online marketplaces include the websites at ebay.com, taobao.com, and ricardo.ch.

Online classified sites can be Internet sites that connect individuals and businesses that are offering goods and services to consumers. Typically, the buyers and sellers are from the same geographic area (city, region, etc.).

Furthermore, generally, the buyers don't register with the site and they don't make a payment online facilitated through the site. Examples of online classified sites include craigslist.com, kijljl.com, and subito.it.

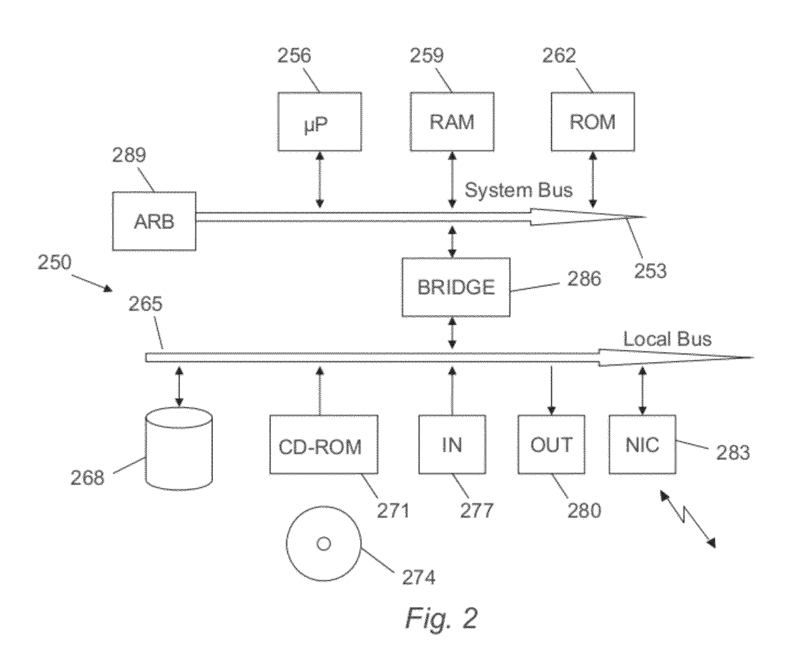

FIG. 2 illustrates a generic computer used in the system according to an embodiment of the present disclosure. Such generic description includes any apparatus provided with processing capabilities, even with different sophistication and functionality levels (e.g., computers, mobile terminals, servers, network routers, server proxies).

Computer 250 includes different units, which are connected in parallel to a system bus 253. In detail, one or more microprocessors 256 control the computer operation. A RAM memory 259 is used directly by the microprocessors 256 as a process memory, while a ROM memory 262 holds the basic code for the initial loading operation (bootstrap) of the system. Various peripheral units are connected to a local bus 265 by way of suitable interfaces. In particular, these peripheral units may include a mass memory formed by hard disk 271 and a CD-ROM and optical disk driver (e.g., DVD or Blu-Ray®) 274. Moreover, the computer 250 may include input devices 277 (e.g., a keyboard, a mouse, or a track point) and output devices 280 (e.g., a screen or a printer). A network card (Network Interface Card) 283 is used to connect the computer 250 to a network. A bridge unit 286 forms an interface between the system bus 253 and the local bus 265. Each microprocessor 256 and the bridge unit 286 may operate as “master agent” and request exclusive access to the system bus 253 for information transmission. An Arbiter 289 manages the access requests to the system bus 253, avoiding conflicts between the requesters. Similar remarks apply to slightly different systems or to systems based on differently configured networks. Other components, beside those described, can be present in specific cases and for particular implementations (e.g., palmtop computers, handheld phones etc).

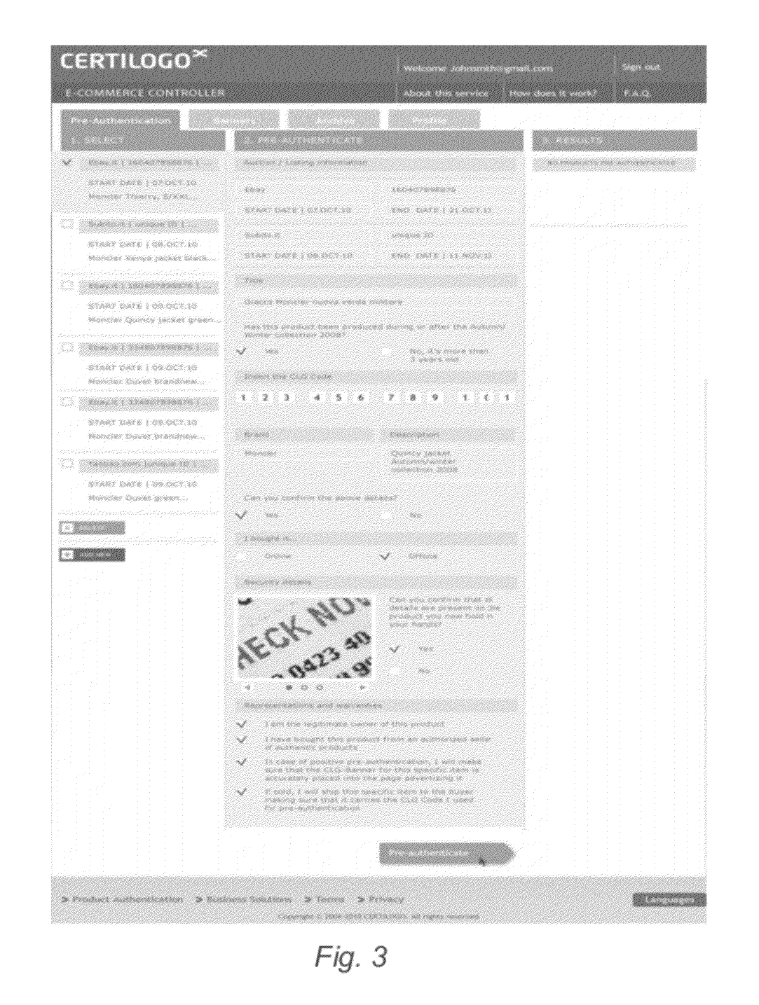

FIG. 3 schematically shows a possible user interface to allow the seller to pre-authenticate the product on sale. The user interface puts the seller in communication with the verification server (see 107 in FIG. 1). This is normally done through a network, e.g. the Internet (see 103 on FIG. 1) and a remote client computer (105 in FIG. 1). Those skilled in the art will easily appreciate that different arrangements are possible: for example, an auction management system or an ERP system from computer clients (105) could communicate in an automated way with the verification server (107) by exchanging files (e.g., XML files) with data required by the verification server, such as the verification code, using established protocols (e.g., web services, HTTP, etc.). The seller is requested to enter a verification code which must be known by the verification server. Several systems are known in the art to manage verification codes and the related verification process, e.g. the Product Authentication Service of Certilogo SpA. According to an embodiment of the present disclosure, the verification code is a condition which must be fulfilled to proceed with the pre-authentication of the product. If desired, other alternative arrangements, where the requirements of a verification code are not so strict, could be implemented. In the present examples some questions have to be answered by the seller: the list of questions can include simple factual information, e.g., the year of manufacture, the description of the item, where does it come from, but also a request to check “visual” information, e.g., the seller is requested to confirm the likeness of, e.g., a hologram or a woven label or particular features of buttons or zippers, or again to verify the likeness of a brand image provided by the verification server through the client computer 105 with the real one being in the hands of the seller. Of course all such pre-authentication procedure starts from the assumption that the information provided by the seller correspond to the truth. The system cannot, of course, be sure that the code entered by the seller is the same printed on the label. The security of the system is “ensured” by the availability of the sellers to undergo a future counter-authentication and the consciousness that their reliability can be put at risk in case of untruthful declarations.

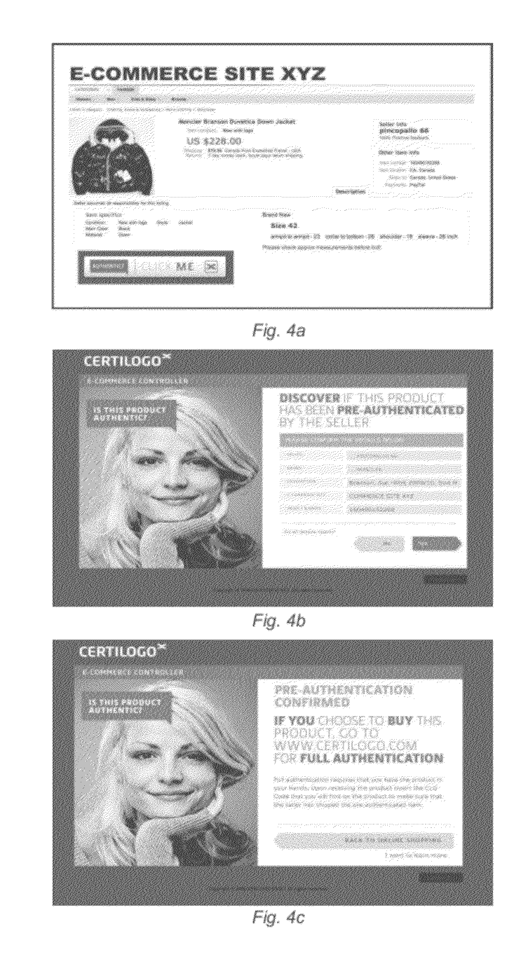

As shown in FIG. 4, the result of the pre-authentication can be a banner or a message to be displayed next to the product on sale which advertises the likelihood of the product being genuine (or, on the contrary, counterfeited in case the process failed) together with the possibility for the customer to check the authenticity of the product after it is received. Several known commercial guarantees can be offered to the customers to alleviate the risk of a buying online. Alternatively a button can be available to the user who can press the icon (button) to obtain more information.

An example is shown in FIG. 4. In particular, FIG. 4a shows an item on sale on an e-commerce site XYZ where an active button is shown. By pressing the button (e.g., by way of a pointer activated by a mouse or track point), the user can be provided with details of the pre-authentication made by the seller (FIG. 4b). This is already an indication of the good intentions of the seller, who makes a sort of representation that the item on sale is authentic (as confirmed by the screenshot shown in FIG. 4c). However, the main point of trust for the customer is knowing that after the purchase this pre-authentication (which, at the moment, relies on information provided by the seller) can be tested.

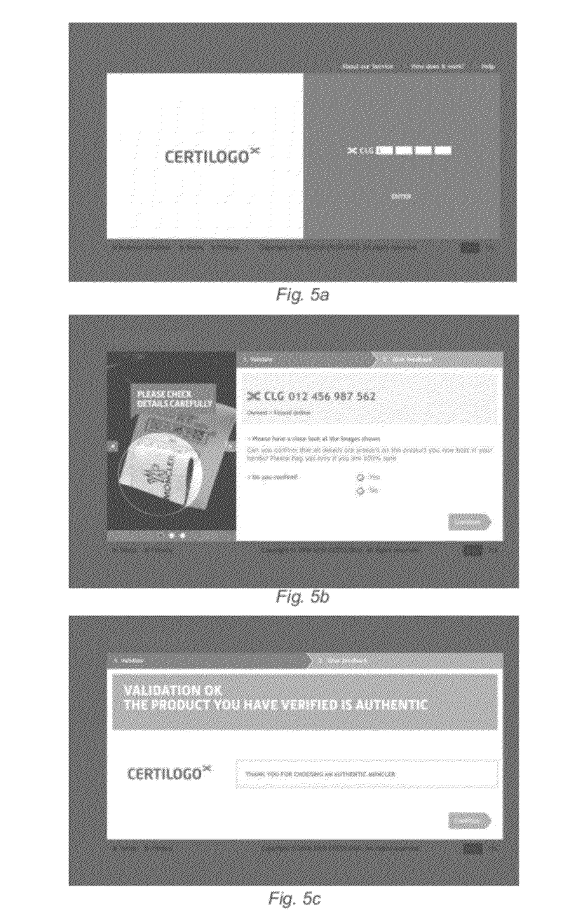

As shown in FIG. 5, the customer, once the purchased product has been received, is offered the possibility to post-authenticate the purchased product. Such post-authentication can include, in accordance with an embodiment of the present disclosure, a check of a verification code accompanied by a list of questions about factual and physical characteristics of the product which is now in the hands of the buyer. In the present example, the questions can include the code itself and a comparison of a visual representation of a detail of the item shown on the client computer 105 with the actual item product in the hands of the customer.

The verification server 107 performs the comparison between the information provided by the customer and the information available on the repository 109. A feedback is then provided to the customer reflecting the result of the post-authentication process. FIG. 5a shows a screenshot where the verification code (or another kind of alphanumeric strings having similar function) is to be provided (e.g., typed) by the customer. In FIG. 5b, the user is shown a picture representing a detail of the product, such as a woven label with the authorized logo of the manufacturer. Finally, in the present example, the result of the authentication process is communicated to the user (FIG. 5c).

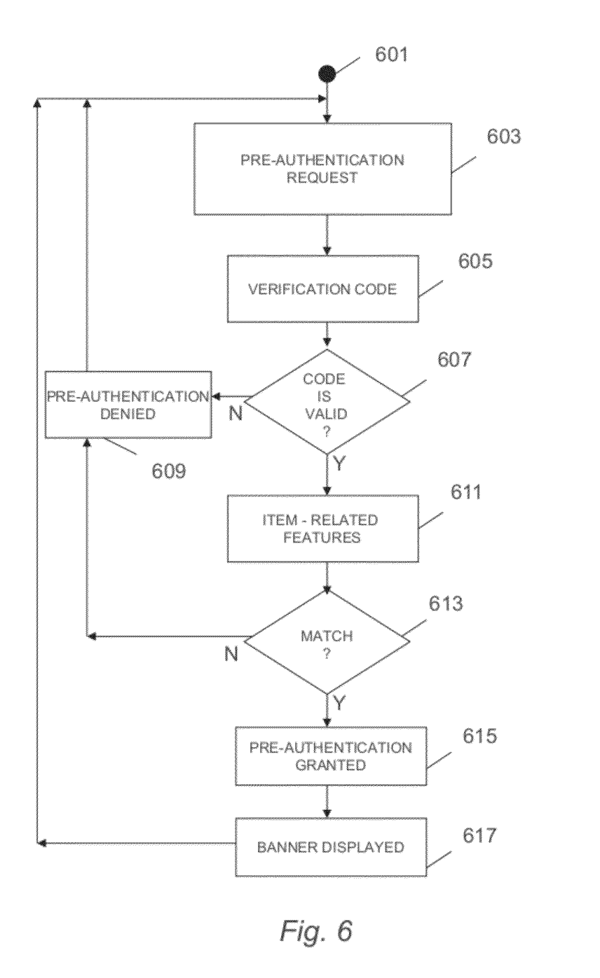

The diagram of FIG. 6 illustrates schematically the steps for a sequence of a pre-authentication method according to an embodiment of the present disclosure. The method is implemented by software and begins at black circle 601, where a daemon waits for a request of pre-authentication to be received from a seller who wishes to advertise on an e-commerce site the sale of an item for which a pre-authentication is performed, in accordance with an embodiment of the present disclosure. When such a request is received (step 603), the system performs a few steps to assess the authenticity of the item to be put on sale. At step 605 the verification code is checked. The seller can enter such code in several different ways, e.g., by typing with a keyboard or any other input device, but also by way of e.g., a bar code reader, OCR reader, NFC enabled mobile phone, mobile phone with SMS functionality, RFID transceiver, vocal messages etc. Verification of the code can be done in several different ways. Those skilled in the art know that many verification systems are available on the market, e.g. the Product Authentication Service of Certilogo SpA, mentioned above, just to make an example. According an embodiment of the present disclosure, if the code is found invalid (step 607) the process denies the pre-authentication and goes back to the start to wait for a new request. An invalid code is meant to be any code which, according to available information, shows a possible authenticity issue, e.g., it does not exist, it was reported stolen from the manufacturer, it was reported as clone/duplicated by customs or, more generally, carries any indication of misuse.

The implementation of the code verification can be done, as mentioned above, in several different ways, and the decision of considering a code as invalid can be dependent on several different rules or policies. Just to make an example, it is possible that the system allows an “acceptance” threshold based on a sort of rating to be given to the code in order to establish its validity or not: this threshold can be customizable by an administrator. If the code is considered valid, then the process goes to step 611, where item-related features are checked. According to an embodiment of the present disclosure, this check is performed with an interactive dialogue between the server and the seller. A sequence of questions is proposed to the seller, who is invited to give one or more details which can be “extracted” from the physical item. The questions can be about one or more of the following information items: brand, model, color, size, origin (i.e. in what city and country the product was purchased), likeness of the brand's logo present on the item, likeness of a hologram on the item, and so on. These are obviously just some examples and the list of question can be selected (e.g., randomly) from a larger set of possible questions. At step 613 the system determines whether the answers received by the seller match the expected information which was previously stored in the repository (see 109 of FIG. 1). Such determination can be made with several different methods and aims at establishing the likelihood that the item is authentic. The authenticity thresholds can be customized and it is even possible that instead of a “binary” response (e.g. “authentic” or “fake”), a score indicative of the likelihood of the item being authentic is provided by the system. In any case, if the check on the item-related features gives a negative results, the pre-authentication is denied (step 609), otherwise it is granted (step 615). According to an embodiment of the present disclosure, the result of a positive pre-authentication is that a message is displayed (step 617) on the e-commerce site to advertise the pre-authentication to possible customers (i.e., to Internet users visiting the e-commerce web site). As mentioned above, this message can take several different formats, e.g. a banner, a stamp or even an active button which offers the possibility to the user to obtain more information on the authentication process. In the present example, the verification of the code is done before the check of the item-related features. However, it would be possible to invert the order of the two verification steps (item-related features first) in order to obtain the same result. It is to be noted that all verifications of the pre-authentication process are built on information provided by the seller. Even the verification code, which can follow some strict rules which should be enough to detect fake codes, is provided by the seller, who could procure a valid code in a malicious way (e.g., by copying a real code in a shop, or selling more than one item with the same code). In other words, there is no guarantee that the information is correct. Therefore the authenticity is not really tested. The pre-authentication process is thus useful for sellers willing to send a message to all possible customers that they are willing to be “tested” with a second authentication process to be performed by the customer after the purchased item is received.

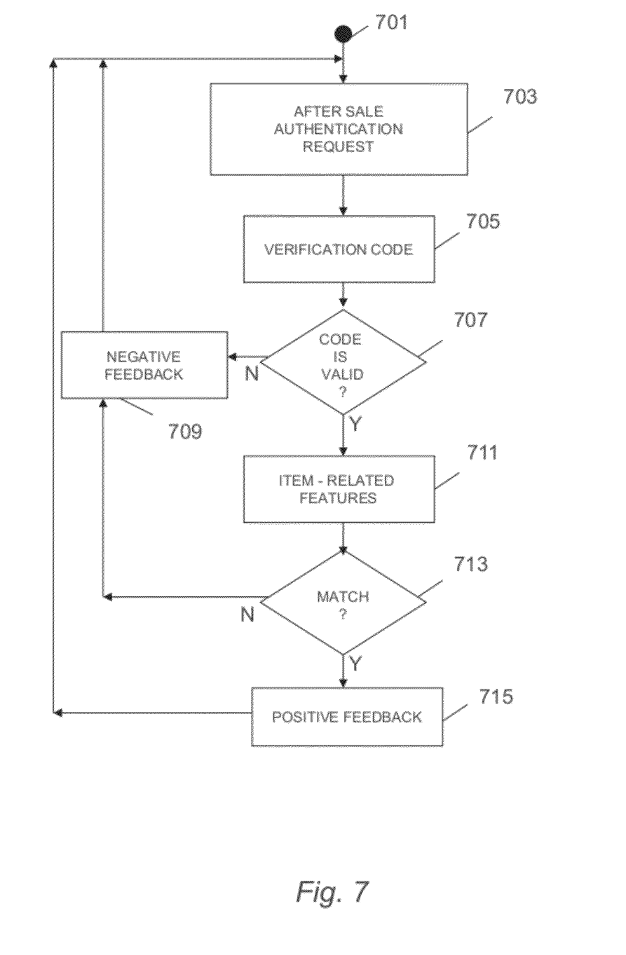

The post-sale authentication process is illustrated in FIG. 7. The process is implemented by software and starts at black circle 701. Such process follows a similar sequence of steps as the pre-authentication, but is performed by the buyer once the item has been received: usually, e-commerce sites offer a delivery by post or courier to an address indicated by the seller, but other arrangements are possible, e.g., the buyer might need or prefer to go and collect the item. In any case, the method and system of the present disclosure are particularly (but not exclusively) useful when the buyer cannot see and touch the item to purchase.

At step 703, a post purchase (after sale) request is received and the first check is on the verification code (step 705). The same considerations made for the pre-authentication process can be done for the post purchase process: the code will be checked in a similar way as done for the pre-authentication. If the code fails the verification (step 707), a negative feedback is conveyed to the buyer (step 709). Alternatively, such negative feedback could be postponed until after the complete verification process has been performed. This could be justified by the possibility that the validity of the verification code is not completely clear. Again, this is a matter of system administrator choice who can decide to impose stricter of softer rules for the authenticity of the items on sale. If the verification code is considered valid, the process goes to the item-related features verification process (step 711), which follows similar rules as the corresponding process described for pre-authentication. If such verification succeeds (step 713), a positive feedback is issued to the buyer, otherwise a message will be delivered (e.g., displayed) to advise that further inquiries might be needed. As occurred for the method described in FIG. 6, in the present example verification of the code is done before the check of the item-related features. However, inversion of the order of the two verification steps (item-related features first) for obtaining the same result is also possible.

In the present disclosure, the pre-authentication and the post purchase authentication processes has been presented as performed in a very similar way and possibly with the same server controlling both processes. However, other arrangements are possible, e.g., one (or more) dedicated server for pre-authentication and one (or more) for post purchase authentication. The pre-authentication could even follow a completely different path than the post purchase, or even be a simple self authentication process from a seller. Also, the code verification process was not discussed in deep detail, as those skilled in the art know that several methods and systems are available to handle such kind of verifications.

In practice, the implementation details can be changed and modified in many equivalent ways as far as the described and shown single constructive elements, without departing from the adopted solution and therefore remaining within the scope of protection accorded to the present patent. A person skilled in the art can modify the solution described above in several ways, with the aim of complying with local or specific requirements, all within the scope of protection of the present disclosure. In particular, it should be noted that, even if implementation details have been given with reference to one or more embodiments, omissions, substitutions or changes of some specific features or steps of the method described can be adopted due to design or manufacturing needs.

For example, the hardware structures could have different configurations and/or include different modules. Throughout the present disclosure, the term “computer” is used to include any apparatus (e.g. telephone, palmtop computer, etc.) having a processing capability, for execution of software programs or part thereof. The programs can be structured in different ways or implemented in any form. In the same way, memories can be of many constructive forms or can be replaced by equivalent entities (not necessarily formed by tangible supports). The programs can be in any form suitable for execution of the related tasks and can be written in any programming language or presented in form of software, firmware or microcode, both in object code and in source code. The programs themselves can be stored on any kind of support, provided that it can be read by a computer. For example, the supports can be: hard disks, removable disks, (e.g. CD-ROM, DVD or Blu-Ray® Disc), tapes, cartridges, wireless connections, networks, telecommunication waves. The supports can be, for example, electronic, magnetic, optical, electromagnetic, mechanical, infrared type or semiconductors.

1. A method for detecting improper use of verification codes of a purchased item sold through an e-commerce site connectable to a verification server, the verification server having access to a repository containing information about a plurality of items, each item of the plurality of items being associated with a verification code and with a plurality of item-related features, the purchased item having been pre-authenticated by a seller through the verification server, wherein the pre-authentication includes checking a verification code and at least one pre-authentication item-related feature selected among the plurality of predetermined item-related features associated to the purchased item, the method including the steps:
responsive to a user request to verify authenticity of an item purchased through the e-commerce site, the verification server prompting the user to provide a verification code;
the verification server determining validity of the code by querying the repository;
responsive to the code being determined valid, the verification server i) selecting at least one item-related feature among the plurality of predetermined item-related features and ii) for each selected item-related feature obtaining information from the user;
the verification server comparing the information obtained by the user with the at least one selected item-related feature to verify the authenticity of the purchased item;
the verification server assigning to the item a score based on the comparison, the score being indicative of the likelihood that the purchased item is authentic; and
the verification server providing the user with a feedback according to the assigned score.

2. The method of claim 1 wherein the at least one selected item-related feature for which information is obtained from the user corresponds to the at least one pre-authentication item-related selected feature.

3. The method of claim 1 wherein the step of obtaining information from the user includes an interactive dialogue.

4. The method of claim 1 wherein the step of obtaining information from the user includes showing a visual representation of an item-related feature and wherein the user is requested to confirm conformity of the purchased item with the visual representation.

5. The method of claim 1 wherein the pre-authentication is a pre-requisite for selling items through the e-commerce site.

6. The method of claim 1, further comprising displaying a message on the e-commerce site advising the users of the possibility of controlling authenticity of purchased items after the purchase has been completed.

7. A verification server computer-readable storage medium having stored thereon computer-executable instructions for performing the steps of the method of claim 1.

8. A verification server computer comprising the verification server computer-readable storage medium of claim 7.

9. A system including one or more components, the system adapted to implement the method of claim 1.
